(19) United States
(12) Patent Application Publication
(10) Pub. No.: US 2010/0088083 A1
(43) Pub. Date: Apr. 8, 2010

(54) Method and Apparatus for Circuit Simulation

(75) Inventor: Steven Leeland, Scottsdale, AZ (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/247,404

(22) Filed: Oct. 8, 2008

(51) Int. Cl. G06G 7/62; G06G 7/48

(52) U.S. Cl. 703/14

(57) ABSTRACT

A method of integrated circuit simulation comprising the steps of providing a voltage lookup table having predetermined drain voltage data for a given transistor type, providing a voltage lookup table having predetermined gate voltage data for a given transistor type. Providing a temperature lookup table having predetermined temperature data. Providing a transistor lookup table having predetermined current and temperature data. Simulating operation of an integrated circuit by, for each transistor in the integrated circuit, determining a current value through the transistor in dependence upon one of the predetermined voltage data values and one of the predetermined temperature data values; and comparing the current value calculated to the current value obtained previously; and updating active transistor list detecting a change in the current value. Then incrementing a simulation time step and repeating simulation steps for all transistors. Simulating operation of an integrated circuit by, for each transistor in the integrated circuit, determining a transistor temperature value for all transistors in the active transistor list.

### FIELD OF THE INVENTION

The present invention relates to methods and apparatus for modeling an electronic device or system to predict its performance or to obtain desired performance and is particularly concerned with simulating low voltage integrated circuits.

### BACKGROUND OF THE INVENTION

Simulation systems are subject to a trade-off between speed and accuracy. In systems designed to speed up the operation of simulation, the accuracy is reduced, and conversely, in a system designed for greater accuracy, the real simulation time increases.

In conventional simulation systems, in the interest of achieving acceptable speed of simulation, the transistor temperature is assumed to be constant throughout a simulation, both in location within the circuit being simulated, and in time during the simulation. Co-owned applications ______ describe a method and apparatus for circuit simulation, which improves the accuracy by recalculating the transistor temperature and current through each transistor, at each step of simulation, in a basic (innermost) element of a plurality of nested loops in the larger simulation system, while employing techniques to limit the consequent increase of real simulation time, to some extent.

There exists a need, however, to reduce the real simulation time further while maintaining the accuracy associated with recalculating the transistor temperature and current through each transistor during each step of simulation.

### SUMMARY OF THE INVENTION

Accordingly, it is an object of the invention to improve the real simulation time of a simulation system and it is another object of the invention to lower the transistor temperature and the current through specific transistors in the layout.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the described objects and/or advantages. Accordingly, the objects and/or advantages described herein are not essential elements of the present invention, and should not be construed as limitations.

### BRIEF DESCRIPTION OF THE FIGURES

In the accompanying drawings:

FIG. 1 is a block diagram of a system for performing circuit simulation.

FIG. 2a is a flow chart describing the methodology used by the state machine according to the embodiment of FIG. 1 for calculating the current through a transistor for a simulation time step.

FIG. 2b is a flow chart describing the methodology used by the state machine according to the embodiment of FIG. 1 for calculating the temperature of a transistor for the simulation time step.

FIG. 3a is a symbolic diagram of the net table of FIG. 1 in greater detail, showing a one dimensional array.

FIG. 3b illustrates inputs to a five element segment of the array of FIG. 3a.

FIG. 4a is a symbolic diagram of the transistor table of FIG. 1 in greater detail, showing another one dimensional array.

FIG. 4b shows inputs to a ten element segment of the array of FIG. 4a.

FIG. 5a is a flow chart which describes the process of determining the normalized adjusted gate voltage data for an n channel MOS transistor according to one embodiment.

FIG. 5b is a flow chart which describes the process of determining the normalized adjusted gate voltage data for an n channel MOS transistor according to an alternate embodiment.

FIG. 6a is a flow chart which describes the process of determining the normalized adjusted gate voltage data for a p channel MOS transistor according to one embodiment.

FIG. 6b is a flow chart which describes the process of determining the normalized adjusted gate voltage data for a p channel MOS transistor according to an alternate embodiment.

FIG. 7a is a flow chart which describes the process of determining the normalized adjusted drain voltage data for the n channel MOS transistor according to one embodiment.

FIG. 7b is a flow chart which describes the process of determining the normalized adjusted drain voltage data for the n channel MOS transistor according to an alternate embodiment.

FIG. 8a is a flow chart which describes the process of determining the normalized adjusted drain voltage data for the p channel MOS transistor according to one embodiment.

FIG. 8b is a flow chart which describes the process of determining the normalized adjusted drain voltage data for the p channel MOS transistor according to an alternate embodiment.

FIG. 9a is a flow chart which describes the process of determining the normalized adjusted temperature data according to one embodiment.

FIG. 9b is a flow chart which describes the process of determining the normalized adjusted temperature data according to an alternate embodiment.

FIG. 10 shows a flow chart for the process of determining the input values, for the relative current coefficient.

### DETAILED DESCRIPTION OF THE FIGURES

This invention is described in the following description with reference to the figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefor known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

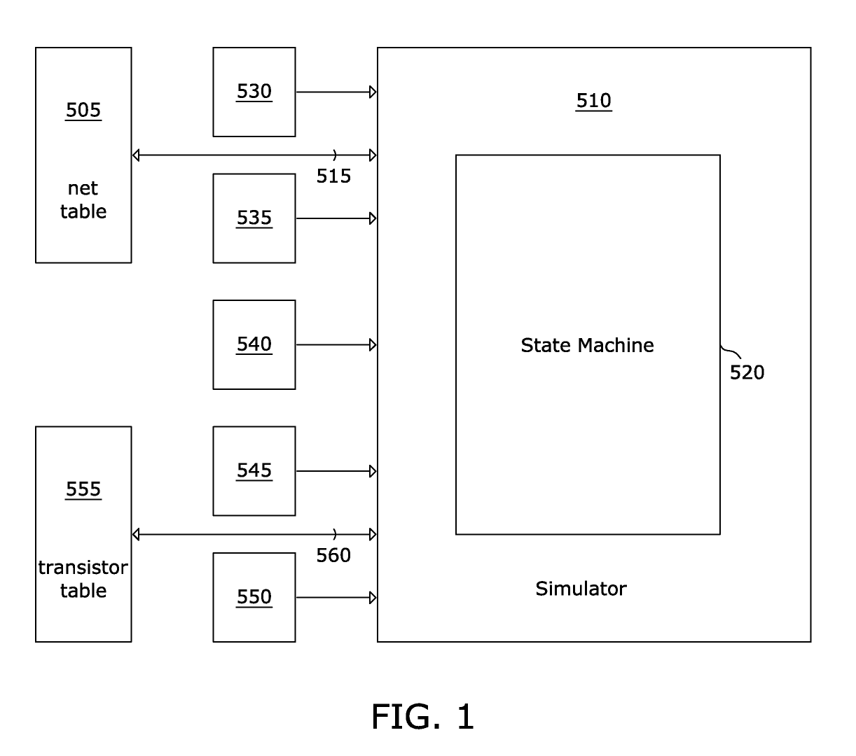

A known mode for carrying out the invention is a circuit simulator shown in FIG. 1 as a block diagram of a system for performing circuit simulation that includes a simulator 510, net table 505, transistor table 555 and gn table 530, gp table 535, dn table 540, dp table 545, and t3/2 table 550 for storing information necessary for the simulation. The simulator 510 includes state machine 520 to calculate the current and temperature of the net in each simulation step.

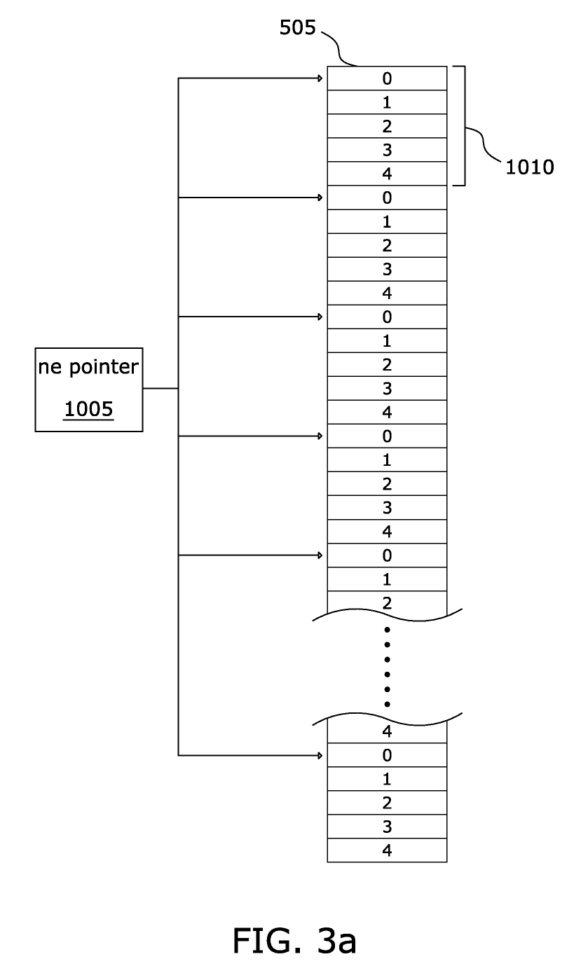

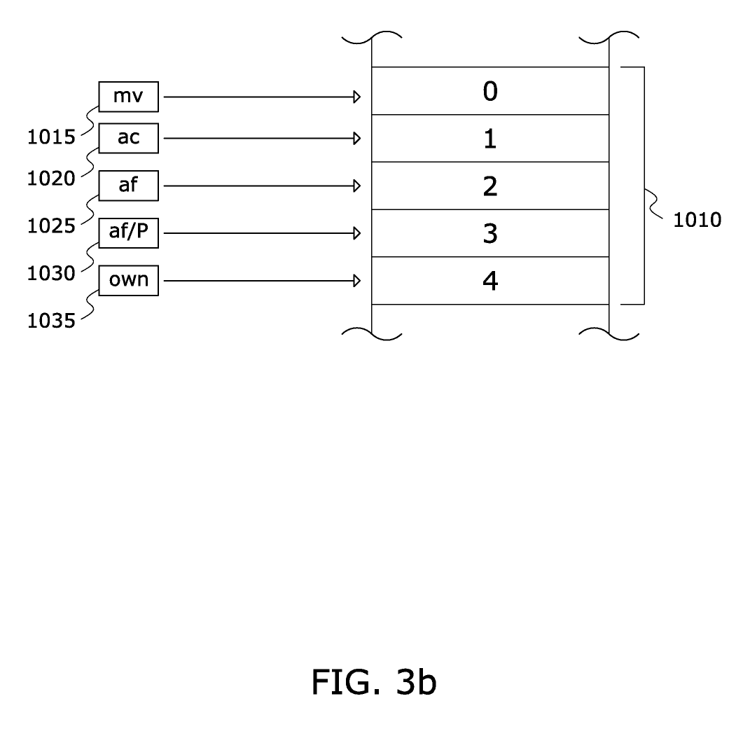

A net table 505 is connected to the simulator 510 through a bidirectional data line 515. The net table 505, explained in further detail in FIG. 3a and FIG. 3b, is an array that includes voltage, charge, capacitance, capacitance to power ratio and the location coordinates data of each net which is used by the simulator 510 for performing circuit simulation. The voltage of the net, the charge of the net, the capacitance of the net, and the capacitance to power ratio of the net can vary for each simulation step and thus the transistor table is updated with the revised voltage of the net, the charge of the net, the capacitance of the net, and the capacitance to power ratio of the net after each simulation. On the other hand, the coordinates of the net's location are not updated by the simulator 510.

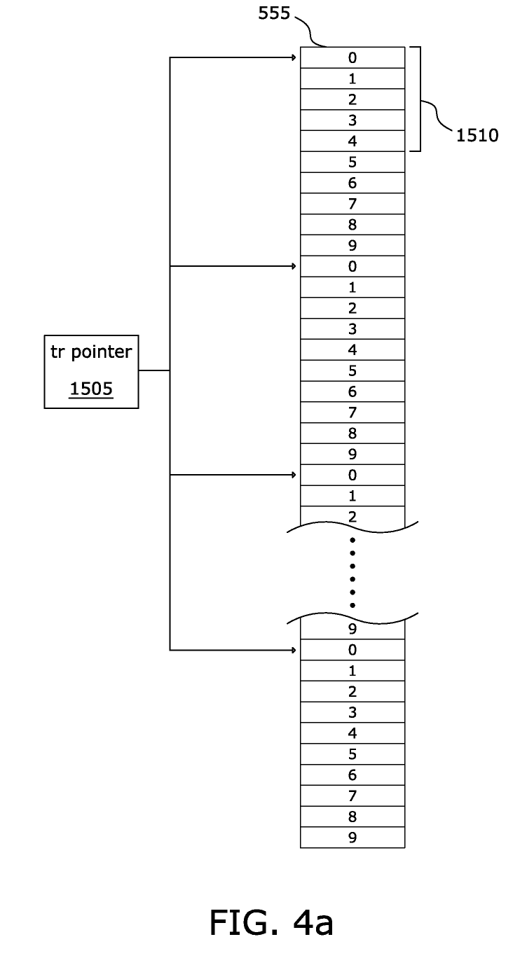

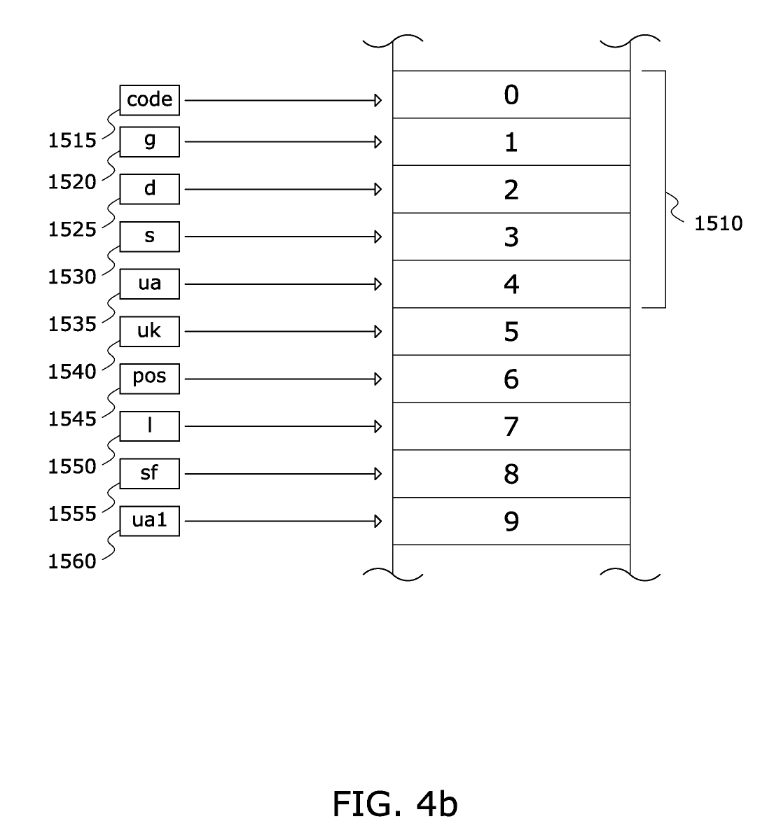

The transistor table 555 is connected to the simulator 510 through a bidirectional data line 560. The transistor table 555, explained in FIG. 4a and FIG. 4b, is an array that includes the temperature of the transistor in degrees Kelvin and the actual current through that transistor, the coordinates of the transistor's gate, the coordinates of the transistor's drain, the coordinates of the transistor's source, the maximum current through that transistor type, the coordinates of the transistor's position, the length in tiles of the transistor, and the shape factor of the transistor, which is used by the simulator 510 for performing circuit simulation. The temperature of the transistor and the actual current through that transistor can vary for each simulation step and thus the transistor table 555 is updated with the revised temperature of the transistor and the actual current through that transistor after each simulation. On the other hand, the coordinates of the transistor's gate, the coordinates of the transistor's drain, the coordinates of the transistor's source, the maximum current through that transistor type, the coordinates of the transistor's position, the length in tiles of the transistor, and the shape factor of the transistor are constant and therefore are not updated by the simulator 510.

The system also includes gn table 530, gp table 535, dn table 540, dp table 540 and t3/2 table 545. The data from the above tables is used by the simulator to simulate the four types of transistors. A type 0 (n-) transistor and a type 1 (p-) transistor are used in the formulation of an inverter where the n-transistor is connected to the power supply voltage V_{dd} and the p-transistor is connected to ground Vₛₛ. A type 2 (n pass) transistor and a type 3 (p pass) transistor are used in the formulation of a pass gate wherein the voltage control (digital input) is connected to first a type 3 p pass transistor and second through an inverter also connected to a type 2 n pass transistor.

State machine 520 calculates the change in temperature of a transistor, by monitoring the current flowing through the transistor at a given simulation step. State machine 520 calculates the current through the transistor using a transistor current equation in which the current through any transistor type is defined as the product of a relative current coefficient C and a reference current I_{ref}, (the preferred maximum current through that transistor type, according to the application).

I=C·I_{ref}

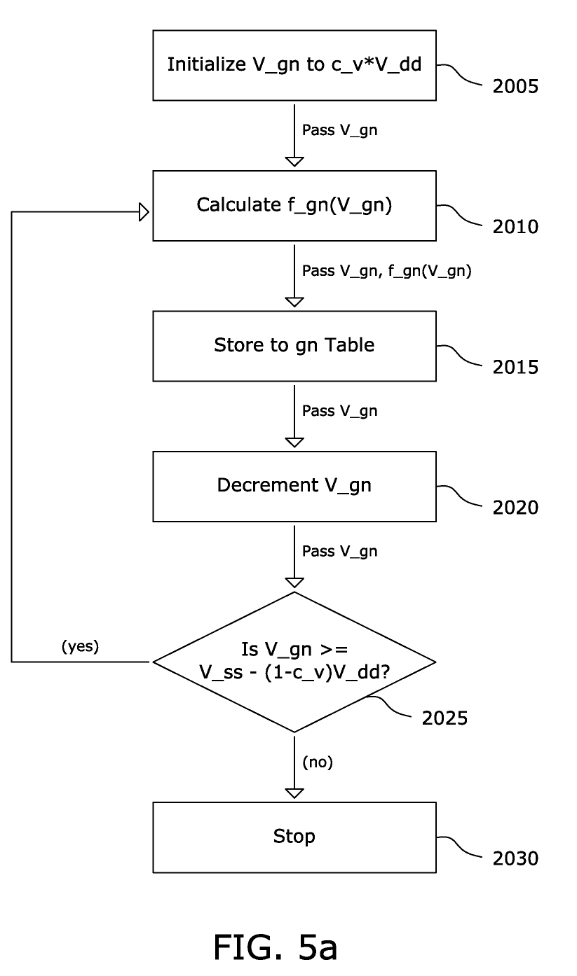

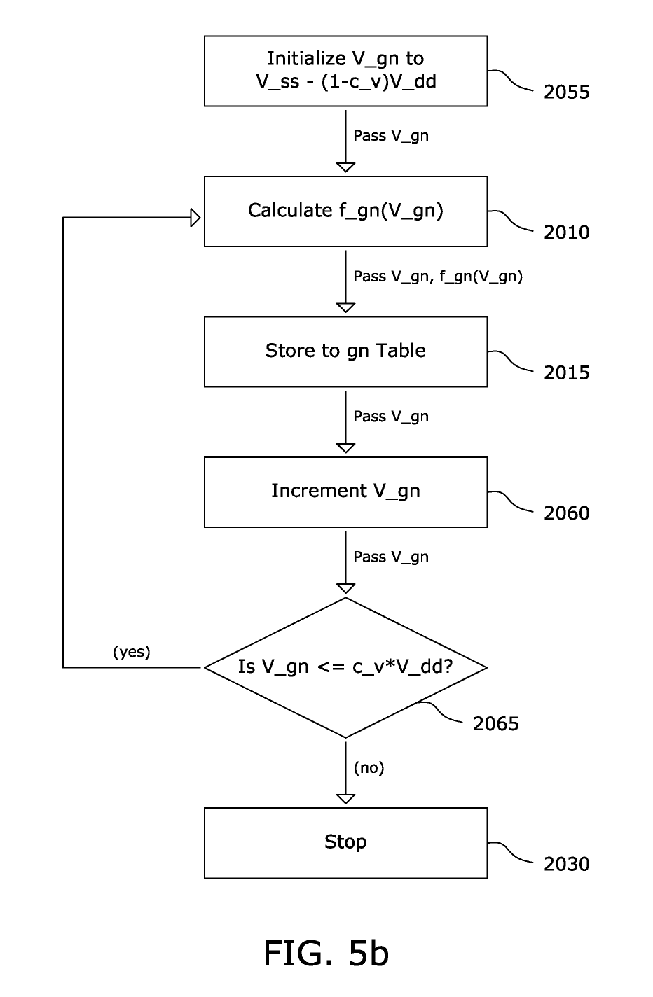

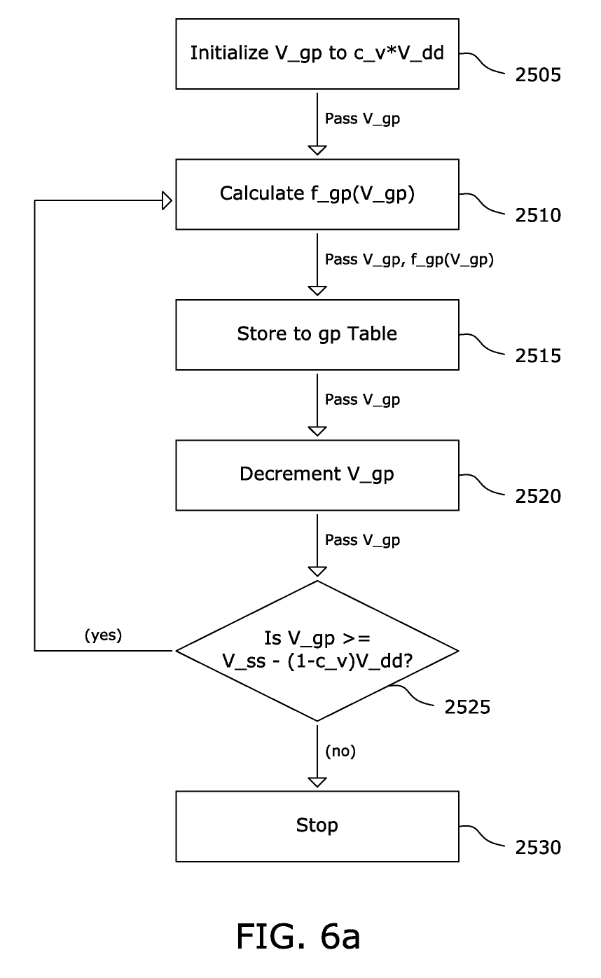

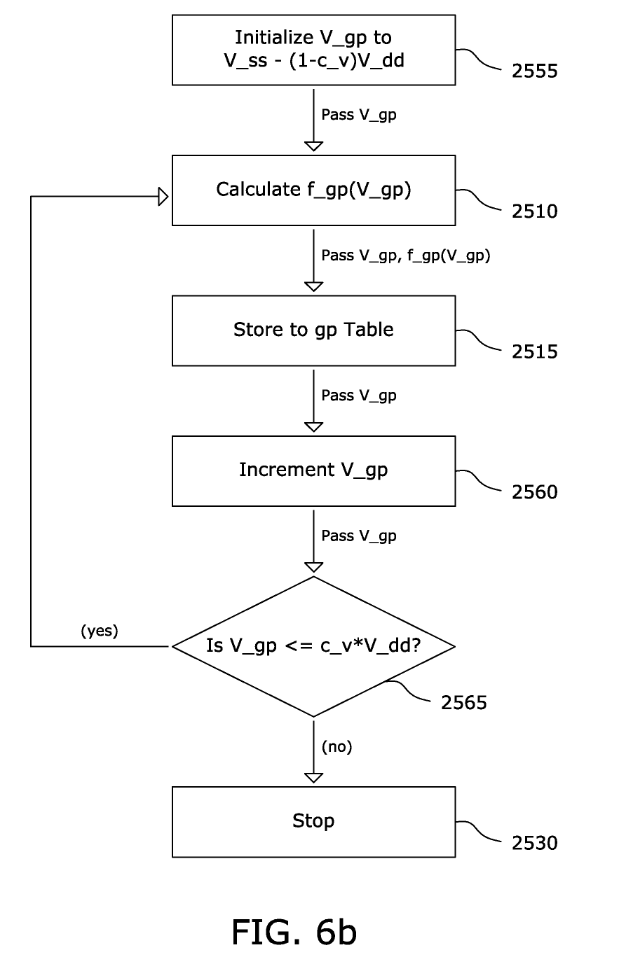

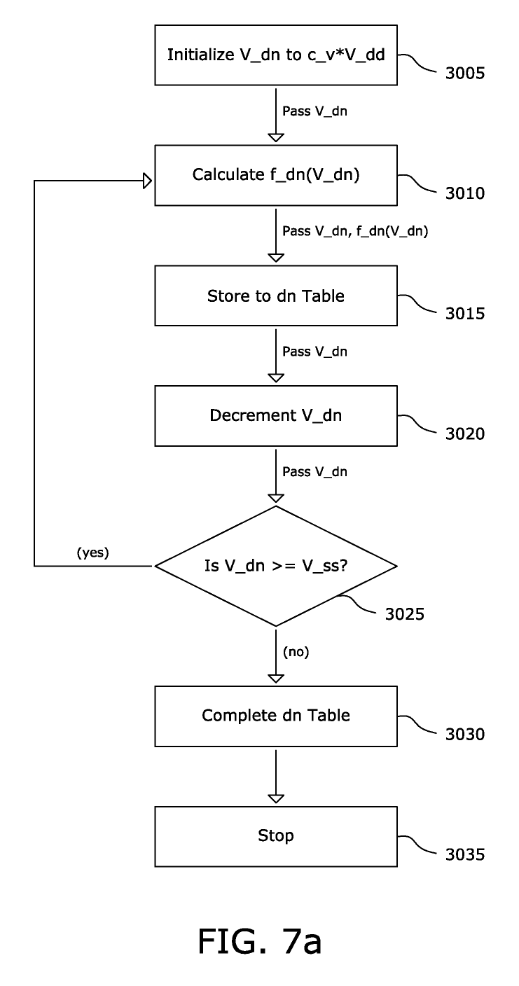

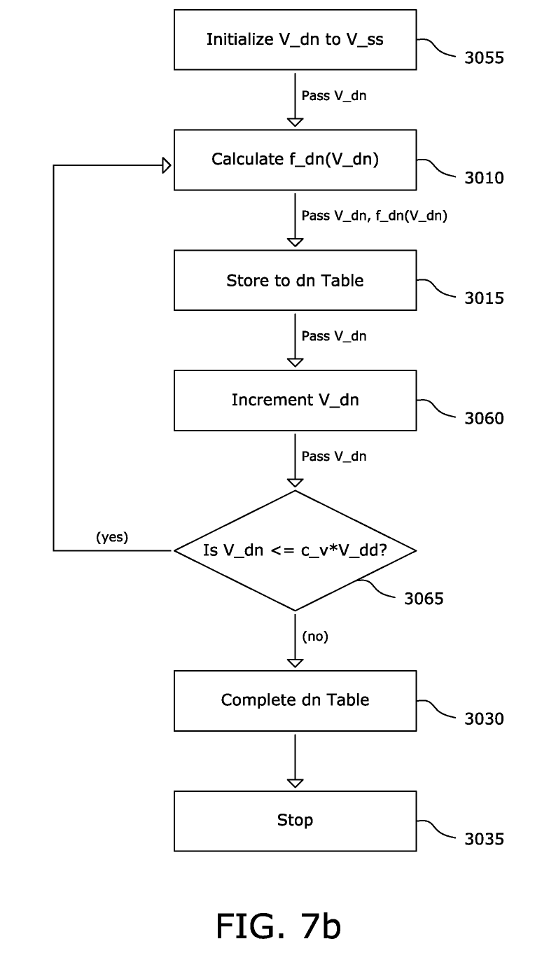

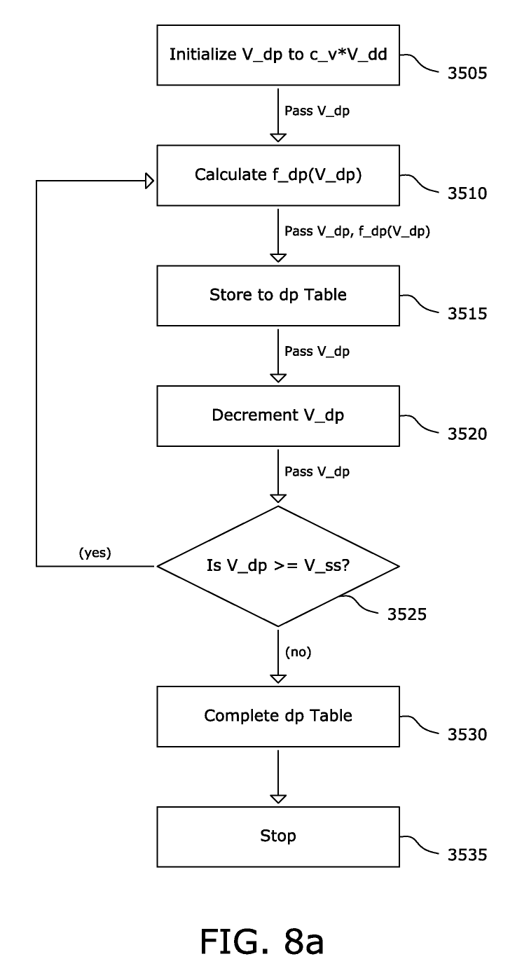

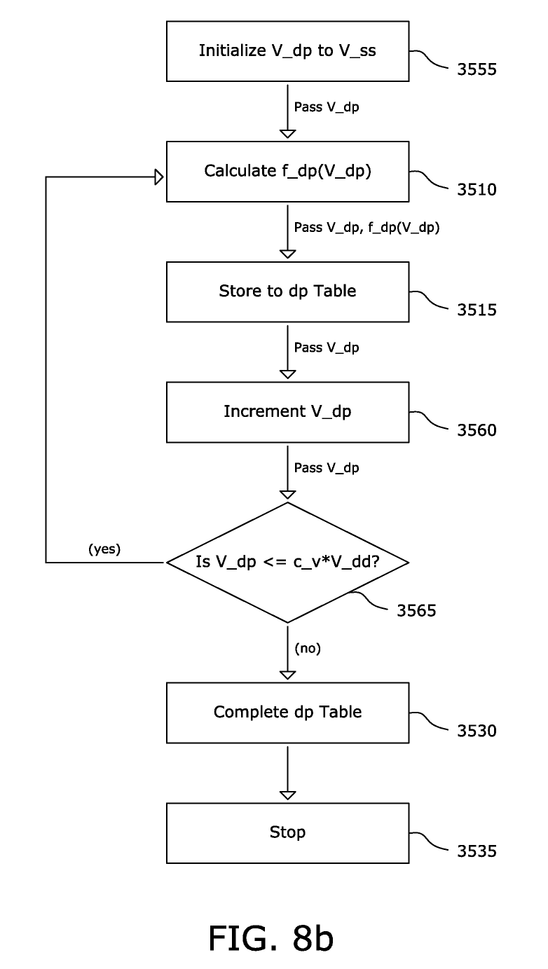

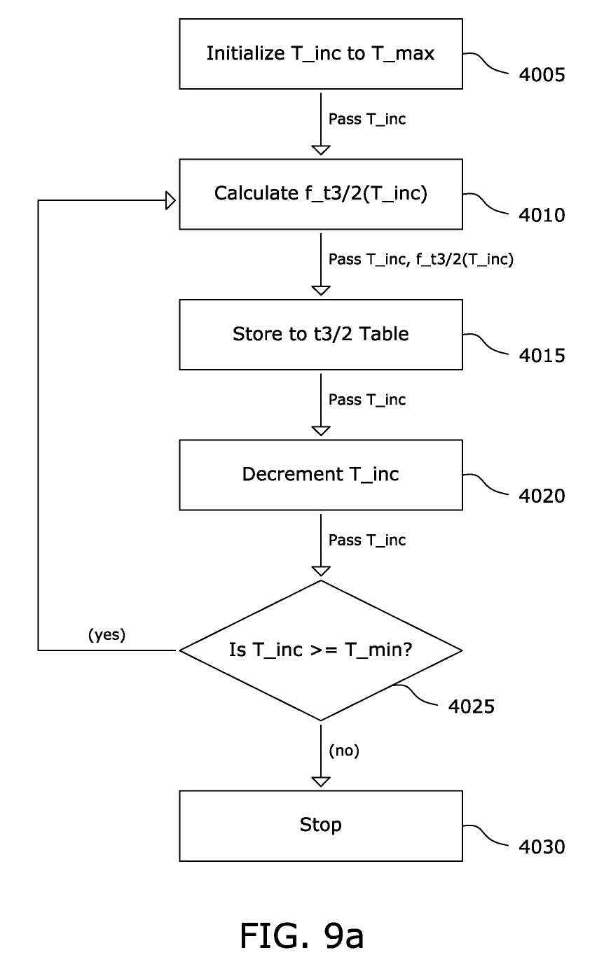

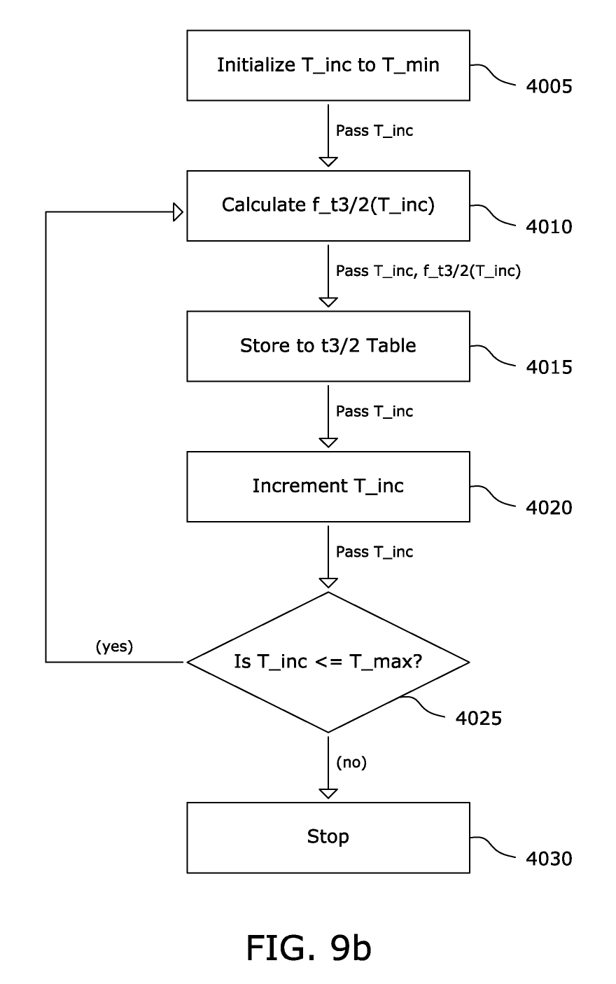

The relative current coefficient C, for an n channel MOS transistor is calculated by combining a single numerical value from the normalized adjusted gate voltage data for n channel MOS transistors stored in a gn table 530 explained in further detail in FIG. 5a, and in an alternate embodiment in FIG. 5b; the normalized adjusted drain voltage data for n channel MOS transistors in a dn table 540 explained in further detail in FIG. 7a, and in an alternate embodiment in FIG. 7b; and the relative temperature data in a t3/2 table 550 explained in further detail in FIG. 9a, and in an alternate embodiment in FIG. 9b. Alternatively, the relative current coefficient C, for a p channel MOS transistor is calculated by combining a single numerical value from the normalized adjusted gate voltage data for p channel MOS transistors in a gp table 535 explained in further detail in FIG. 6a, and in an alternate embodiment in FIG. 6b; the normalized adjusted drain voltage data for p channel MOS transistors in a dp table 545 explained in further detail in FIG. 8a, and in an alternate embodiment in FIG. 8b; and the relative temperature data in the t3/2 table 550.

The state machine reads the reference current I_{ref} of the transistor from the transistor table 555 using the data line 560 which is calculated during the previous simulation step and updates the transistor table 555 with the current value I calculated at current simulation step.

The temperature of the transistor is calculated from the current I through the transistor by means of a transistor temperature equation where the transistor temperature T is the sum of transistor temperature from the previous simulation step T and an adjustment ΔT.

T=T+ΔT

The previously computed transistor temperature T is held in the transistor table 555 as one of the ten elements stored for each transistor of the circuit. The numerical value of the adjustment to the temperature ΔT is calculated by the state machine 520 based on whether the transistor is heating up or cooling down.

If the transistor is heating up (increase in temperature), the adjustment to the temperature ΔT is determined by means of the general form of an increasing transistor temperature change equation from the product of an increasing temperature change index x_{incr}, and a first relative temperature coefficients C₁, which yields an exponential increase of the transistor temperature towards the equilibrium transistor temperature.

ΔT=C₁·x_{incr}

The value assigned to the increasing temperature change index x_{incr} is determined from the difference in the present temperature of the transistor and the equilibrium transistor temperature. The greater the difference between the present transistor temperature and the equilibrium transistor temperature the larger the value of the increasing temperature change index and when combined with the first relative temperature coefficient C₁ the more rapidly the transistor's temperature will approach the equilibrium transistor temperature.

If the transistor is cooling down (decrease in temperature), the adjustment to the temperature ΔT is determined by means of the general form of a decreasing transistor temperature change equation from the product of a decreasing temperature change index x_{decr} to the third power and a second relative temperature coefficients C₂ which yields a cubic decrease of the transistor temperature away from the equilibrium transistor temperature.

ΔT=C₂·x_{decr}³

The value assigned to the decreasing temperature change index x_{decr} is determined from the difference in the present temperature of the transistor and the equilibrium transistor temperature. The greater the difference between the present transistor temperature and the equilibrium transistor temperature, the larger the value of the decreasing temperature change index.

The increasing temperature change index and the decreasing temperature change index are computed in exactly the same way in a temperature change index equation and is determined from the sum of two terms. The first of the two terms is the temperature of the transistor from the previous simulation time step and the second of which is the product of a power consumed by the transistor P and a third temperature coefficients C₃ divided by a transistor specific shape factor F.

$$x = T + \frac{P \cdot {C}_{3}}{F}$$

Again, the transistor temperature T, is contained in the transistor table 555 and is read by the state machine 520 using the data line 560. The transistor shape factor F is computed as the product of the length in tiles of the transistor, a value stored in the transistor table of block 555, and is read by the state machine 520 using the data line 560, and a coefficient not shown in the temperature change index equation. The power consumed by the transistor P, is calculated in a power equation as the absolute value of the product of the current through the transistor I and the difference in the voltage between the drain V_{d} and source Vₛ.

P=|I·(V_{d}−Vₛ)|

Again, the current I, drain voltage V_{d}, and source voltage Vₛ is contained in the transistor table 555 read by the state machine 520 using the data line 560.

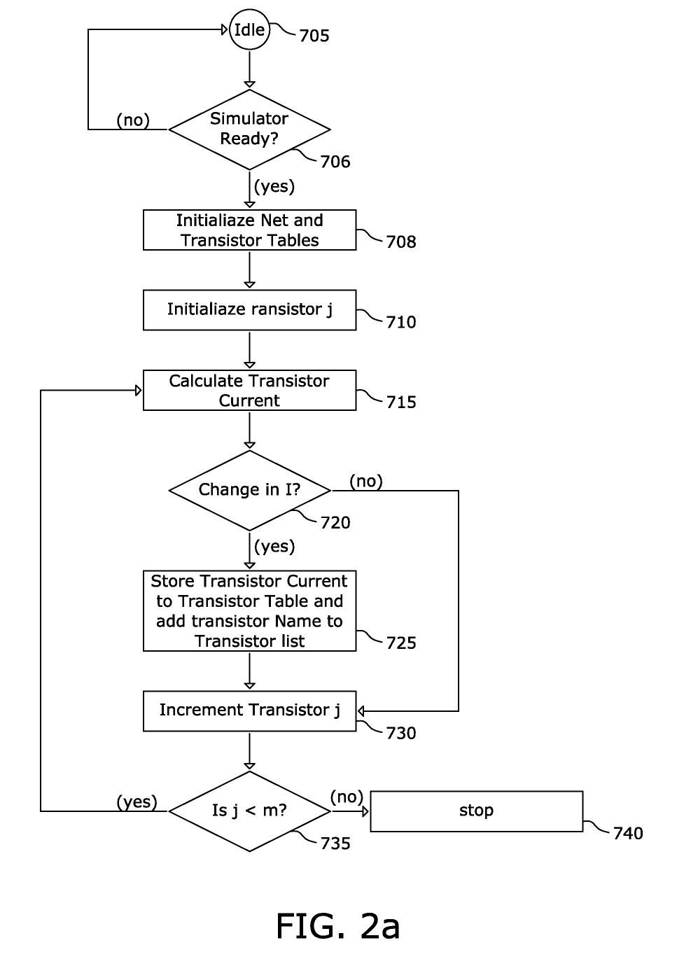

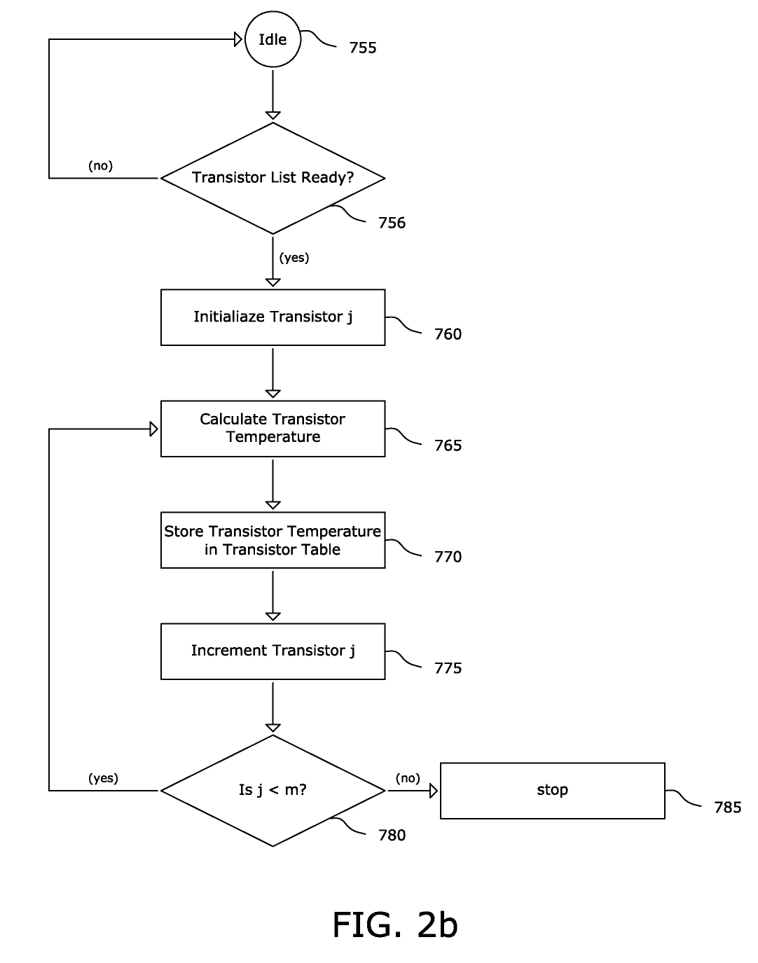

FIG. 2a is a flow chart describing the methodology used by the state machine 520 for calculating the current through a transistor for each simulation step. In the power up condition the state machine is in an idle state 705. In a step 706, the state machine verifies if the simulator is ready. If the simulator is ready in a step 706, then in a step 708 the net table 505 and the transistor table 555 are initialized to predetermined values which can be based on the process technologies. Otherwise the state machine returns to the idle state 705. The transistor table 555 includes data for m transistors and a transistor j is initialized in a step 710. For example,j=1 corresponds to the first transistor in the transistor table 555. The transistor current is calculated in a step 715 using a form of equation 5. In a step 720 the current I is compared to the current stored in the transistor table from the previous simulation time step. In a step 725, a change to the current (in step 720) adds the transistor name to the non quiescent current transistor list 580 and updates the current value in the transistor table 555. In a step 730 the transistor j is incremented to the next transistor in the transistor table 555. If there is no change to the current in the step 720, the step 730 is performed. If the transistor j is not the last transistor in the transistor table 555 in a step 735, step 715 is repeated. Otherwise the flow chart ends in a step 740.

FIG. 2b is a flow chart describing the methodology used by the state machine 520 for calculating the temperature of a transistor for each simulation time step. In the power up condition the state machine is in an idle state 755. In a step 756, the state machine verifies if the non quiescent current transistor list 580 is complete for the simulation time step. If the non quiescent current transistor list 580 is ready in a step 756, then in a step 760 a transistor j is initialized. Otherwise the state machine returns to the idle state 755. For example, j=1 corresponds to the first transistor in the non quiescent current transistor list 580. In a step 765 a temperature of the transistor is calculated by means of the general form of equation 10. In a step 770 the temperature value is updated in the transistor table 555. In a step 775 the transistor j is incremented to the next transistor in the non quiescent current transistor list 580. If the transistor j is not the last transistor in the non quiescent current transistor list 580 in a step 780, step 765 is repeated. Otherwise the operation of the state machine ends in a step 785 by discarding the transistors from the non quiescent current transistor list 580.

In a yet alternate embodiment, in step 725, if there is no change to the current, the transistor can still be included in the non quiescent current transistor list 580 if it is in a non quiescent temperature list; and in step 770, prior to updating the temperature value in the table 555, the temperature value determined in step 765 can be compared to the prior temperature value in table 555, and the transistor can be entered in, or removed from, the non quiescent temperature list, depending on whether or not the temperature value is different from the prior value by a predetermined temperature increment. The non quiescent temperature list can be, for example, an additional table of transistor names which is an input to the simulator 510. The temperature increment may be chosen, for example, to be a fixed number of Kelvin (degrees C.), or alternatively, to be a predetermined fraction of the difference between an expected maximum temperature and the quiescent temperature of the transistor. A small predetermined temperature increment tends to improve the accuracy of simulation but will also increase the real time of simulation as it will cause the element to be included in a larger number of subsequent simulation steps when the current is not changing; and conversely, a large predetermined temperature increment will not improve the accuracy as much but will result in faster real time of simulation.

In one embodiment a one dimensional array which contains the net table 505 is shown in FIG. 3a. In an alternate embodiment the array could be multi-dimensional. Accessing a particular net within the net table 505 is done in a manner that is similar to accessing an element contained in a two dimensional array, two indices are required. The first of the two indices is an ne pointer. The ne pointer 1005 is used to access every fifth element in the net table 505. The second of the two indices is a numerical value zero through four which determines the element from the net table 505 contained within a five block region associated with each net.

FIG. 3b shows a particular five element segment from FIG. 3a. The five element segment 1010 contains information for the net. An mv pointer is used to address the first element in the five element segment 1010, the voltage in millivolts of the net. An ac pointer is used to address the second element in the five element segment 1010, the charge in attocoulombs of the net. An af pointer is used to address the third element in the five element segment 1010, the capacitance of the net. An af/p pointer is used to address the fourth element in the five element segment 1010, the capacitance to power ratio of the net. Last, an own pointer is used to address the fifth element in the five element segment 1010, the coordinates of the net's owner. The mv pointer 1015, ac pointer 1020, af pointer 1025, af/p pointer 1030, and the own pointer 1035, while used for addressing data can alternatively be used to address data structures.

In one embodiment a one dimensional array which contains the transistor table 555 is shown in FIG. 4a. In an alternate embodiment the array could be multi-dimensional. Accessing a particular transistor within the transistor table 555 is done in a manner that is similar to accessing an element contained in a two dimensional array, two indices are required. The first of the two indices is a tr pointer. The tr pointer 1505 is used to access every tenth element in the transistor table 555. The second of the two indices is a numerical value zero through nine which determines the element from the transistor table 555 contained within a ten block region associated with each transistor.

FIG. 4b shows a particular ten element segment from FIG. 4a. The five element segment 1510 contains information for the transistor. A code pointer is used to address the first element in the ten element segment 1010, the transistor type. A g pointer is used to address the second element in the ten element segment 1010, the coordinates of the transistor's gate. A d pointer is used to address the third element in the ten element segment 1010, the coordinates of the transistor's drain. An s pointer is used to address the fourth element in the ten element segment 1010, the coordinates of the transistor's source. A ua pointer is used to address the fifth element in the ten element segment 1010, the maximum current through that transistor type. A uk pointer is used to address the sixth element in the ten element segment 1010, the temperature of the transistor in Kelvin. A pos pointer is used to address the seventh element in the ten element segment 1010, the coordinates of the transistor's position. A 1 pointer is used to address the eighth element in the ten element segment 1010, the length in tiles of the transistor. A sf pointer is used to address the ninth element in the ten element segment 1010, the shape factor of the transistor. Last, a ual pointer is used to address the tenth element in the ten element segment 1010, the actual current through the transistor. The code pointer 1515, g pointer 1520, d pointer 1525, s pointer 1530, ua pointer 1535, uk pointer 1540, pos pointer 1545, 1 pointer 1550, sf pointer 1555, and ual pointer 1560, while used for addressing data can alternatively be used to address data structures.

In one embodiment the process of formulating the normalized adjusted gate voltage data in the gn table 530 is shown in a flow chart of FIG. 5a. The m elements of the gn table 530 are determined beginning with a step 2005 which initializes the gate voltage V_{gn} for an n channel MOS transistor to cᵥV_{dd} where cᵥ is a power supply voltage coefficient that can be chosen according to the simulation being performed. For example, cᵥ is 1.0683 and V_{dd} is 1800 mV, resulting in an initial gate voltage of 1923 mV. The gn table preferably includes 2048 elements, but alternatively a different number of elements may be used. The gate voltage is used in a step 2010 wherein it is the argument to the function shown in a normalized adjusted gate voltage for an n channel MOS transistor equation for determining the normalized adjusted gate voltage data for the n transistor.

$${f}_{gn} ( {V}_{gn} ) = {( \frac{max ( 0 , {V}_{gn} - {V}_{tn} + {C}_{mv / k} \cdot ( {T}_{a} - {T}_{r} ) )}{{V}_{dd} - {V}_{tn} + {C}_{mv / k} \cdot ( {T}_{a} - {T}_{r} )} )}^{2}$$

There are several constants shown in the normalized adjusted gate voltage for an n channel MOS transistor equation necessary in producing the normalized adjusted gate voltage data 530. These include, with the units shown in square brackets, the threshold voltage for the n channel MOS transistor Vₜₙ [mV], the millivolts per Kelvin constant C_{mv/k} [mV/K], the ambient temperature at which the simulation will take place Tₐ [K], the reference temperature Tᵣ [K], and the positive supply voltage V_{dd} [mV]. A multiplication factor of k is applied to the numerator of the normalized adjusted gate voltage for an n channel MOS transistor equation in the step 2010 to avoid a loss of precision when the integer data type is used to perform the computation of the normalized adjusted gate voltage for an n channel MOS transistor equation. Hence, the normalized adjusted gate voltage data 530 produced in the normalized adjusted gate voltage for an n channel MOS transistor equation is a factor of k greater than the value produced when performing the computation of the normalized adjusted gate voltage for an n channel MOS transistor equation with floating point arithmetic.

In a step 2015 the normalized adjusted gate voltage data value produced in the step 2010 is stored into the gn table 530 at a position designated by the argument to the function of the normalized adjusted gate voltage for an n channel MOS transistor equation. The formulation of the gn table 530 is done so that the first element of the gn table 530 contains f_{gn}(Vₛₛ−(1−cᵥ)V_{dd}), the second element of the gn table 530 contains f_{gn}(Vₛₛ−(1−cᵥ)V_{dd}+1), and so on until the last element of the gn table 530 contains f_{gn}(cᵥV_{dd}). For example, Vₛₛ is 0 mV, cᵥ is 1.0683, and V_{dd} is 1800 mV, resulting in first element of the gn table 530 contains f_{gnp}(−124), the second element of the gn table 530 contains f_{gn}(−123), and so on until the last element of the gn table 530 contains f_{gn}(1923). However, in the step 2015 only one element of the gn table 530 is filled. Moving to a step 2020 the gate voltage is decremented and is compared to a stop value Vₛₛ−(1−cᵥ)V_{dd} in a step 2025. For example, Vₛₛ is 0 mV, cᵥ is 1.0683, and V_{dd} is 1800 mV, resulting in the stop value −124 mV. The decrement is preferably one millivolt, but an alternative decrement may be used. A yes from the step 2025 indicates that the gate voltage is greater than or equal to −124 mV and step 2010 is repeated. A no from the step 2025 indicates that the gate voltage is less than −124 mV and the flow chart of FIG. 5a ends in a step 2030.

In an alternate embodiment the process of formulating the normalized adjusted gate voltage data in the gn table 530 is shown in a flow chart of FIG. 5b. The m elements of the gn table 530 are determined beginning with a step 2055 which initializes the gate voltage V_{gn} for an n channel MOS transistor to Vₛₛ−(1−cᵥ)V_{dd} where cᵥ is the power supply voltage coefficient that can be chosen according to the simulation being performed. For example, Vₛₛ is 0 mV, cᵥ is 1.0683 and V_{dd} is 1800 mV, resulting in an initial gate voltage of 1923 mV. The gn table preferably includes 2048 elements, but alternatively a different number of elements may be used. This value is used in the step 2010 in which it is used as the argument to the function shown in the normalized adjusted gate voltage for an n channel MOS transistor equation for determining the normalized adjusted gate voltage data for the n transistor. In the step 2015 the normalized adjusted gate voltage data value produced in the step 2010 is stored into the gn table 530 at a position designated by the argument to the function of the normalized adjusted gate voltage for an n channel MOS transistor equation. Moving to a step 2060 the gate voltage is incremented and is compared to a stop value cᵥV_{dd} in a step 2065. For example, cᵥ is 1.0683 and V_{dd} is 1800 mV, resulting in the stop value 1923 mV. The increment is preferably one millivolt, but an alternative increment may be used. A yes from the step 2065 indicates that the gate voltage is less than or equal to 1923 mV and step 2010 is repeated. A no from the step 2065 indicates that the gate voltage is greater than 1923 mV and the flow chart of FIG. 5b ends in the step 2030.

In one embodiment the process of formulating the normalized adjusted gate voltage data in the gp table 535 is shown in a flow chart of FIG. 6a. The m elements of the gp table 535 are determined beginning with a step 2505 which initializes the gate voltage V_{gp} for a p channel MOS transistor to cᵥV_{dd} where cᵥ is a power supply voltage coefficient that can be chosen according to the simulation being performed. For example, cᵥ is 1.0683 and V_{dd} is 1800 mV, resulting in an initial gate voltage of 1923 mV. The gp table preferably includes 2048 elements, but alternatively a different number of elements may be used. The gate voltage is used in a step 2510 wherein it is the argument to the function shown in a normalized adjusted gate voltage for a p channel MOS transistor equation.

$${f}_{gp} ( {V}_{gp} ) = {( \frac{max ( 0 , {V}_{gp} - {V}_{tp} + {C}_{mv / k} \cdot ( {T}_{a} - {T}_{r} ) )}{{V}_{dd} - {V}_{tp} + {C}_{mv / k} \cdot ( {T}_{a} - {T}_{r} )} )}^{2}$$

There are several constants shown in the normalized adjusted gate voltage for a p channel MOS transistor equation necessary in producing the normalized adjusted gate voltage data 535. These include, with the units shown in square brackets, the threshold voltage for the p channel MOS transistor Vₜₚ [mV], the millivolts per Kelvin constant C_{mv/k} [mV/K], the ambient temperature at which the simulation will take place Tₐ [K], the reference temperature Tᵣ [K], and the positive supply voltage V_{dd} [mV]. A multiplication factor of k is applied to the numerator of the normalized adjusted gate voltage for a p channel MOS transistor equation in the step 2510 to avoid a loss of precision when the integer data type is used to perform the computation of the normalized adjusted gate voltage for a p channel MOS transistor equation. Hence, the normalized adjusted gate voltage data 535 produced in the normalized adjusted gate voltage for a p channel MOS transistor equation is a factor of k greater than the value produced when performing the computation of the normalized adjusted gate voltage for a p channel MOS transistor equation with floating point arithmetic.

In a step 2515 the normalized adjusted gate voltage data value produced in the step 2510 is stored into the gp table 535 at a position designated by the argument to the function of the normalized adjusted gate voltage for a p channel MOS transistor equation. The formulation of the gp table 535 is done so that the first element of the gp table 535 contains f_{gp}(Vₛₛ−(1−cᵥ)V_{dd}), the second element of the gp table 535 contains f_{gp}(Vₛₛ−(1−cᵥ)V_{dd}+1), and so on until the last element of the gp table 535 contains f_{gp}(cᵥV_{dd}). For example, Vₛₛ is 0 mV, cᵥ is 1.0683, and V_{dd} is 1800 mV, resulting in the first element of the gp table 535 contains f_{gp}(−124), the second element of the gp table 535 contains f_{gp}(−123), and so on until the last element of the gp table 535 contains f_{gp}(923). However, in the step 2515 only one element of the gp table 535 is filled. Moving to a step 2520 the gate voltage is decremented one millivolt and is compared to a stop value Vₛₛ−(1−cᵥ)V_{dd}. For example, Vₛₛ is 0 mV, cᵥ is 1.0683, and V_{dd} is 1800 mV, resulting in the stop value −124 mV. The decrement is preferably one millivolt, but an alternative decrement may be used. A yes from the step 2525 indicates that the gate voltage is greater than or equal to −124 mV and step 2510 is repeated. A no from the step 2525 indicates that the gate voltage is less than −124 mV and the flow chart of FIG. 6a ends in a step 2530.

In an alternate embodiment the process of formulating the normalized adjusted gate voltage data in the gp table 535 is shown in a flow chart of FIG. 6b. The m elements of the gp table 535 are determined beginning with a step 2555 which initializes the gate voltage V_{gp} for a p channel MOS transistor to Vₛₛ−(1−cᵥ)V_{dd} where cᵥ is the power supply voltage coefficient that can be chosen according to the simulation being performed. For example, Vₛₛ is 0 mV, cᵥ is 1.0683, and V_{dd} is 1800 mV, resulting in an initial gate voltage of 1923 mV. The gp table preferably includes 2048 elements, but alternatively a different number of elements may be used. This value is used in the step 2510 in which it is used as the argument to the function shown in the normalized adjusted gate voltage for a p channel MOS transistor equation for determining the normalized adjusted gate voltage data for the n transistor. In the step 2515 the normalized adjusted gate voltage data value produced in the step 2010 is stored into the gp table 535 at a position designated by the argument to the function of the normalized adjusted gate voltage for a p channel MOS transistor equation. Moving to a step 2560 the gate voltage is incremented and is compared to a stop value CᵥV_{dd} in a step 2565. For example, cᵥ is 1.0683 and V_{dd} is 1800 mV, resulting in a stop value of 1923 mV. The increment is preferably one millivolt, but an alternative increment may be used. A yes from the step 2565 indicates that the gate voltage is less than or equal to 1923 mV and step 2510 is repeated. A no from the step 2565 indicates that the gate voltage is greater than 1923 mV and the flow chart of FIG. 6b ends in the step 2530.

In one embodiment the process of formulating the normalized adjusted drain voltage data in the dn table 540 is shown in a flow chart of FIG. 7a. The m elements of the dn table 540 are determined beginning with a step 3005 which initializes the drain voltage V_{dn} for an n channel MOS transistor to cᵥV_{dd} where cᵥ is a power supply voltage coefficient that can be chosen according to the simulation being performed. For example, cᵥ is 1.0683 and V_{dd} is 1800 mV, resulting in an initial drain voltage of 1923 mV. The dn table preferably includes 2048 elements, but alternatively a different number of elements may be used. The drain voltage is used in a step 3010 wherein it is the argument to the function shown in a normalized adjusted drain voltage for an n channel MOS transistor equation.

$${f}_{dn} ( {V}_{dn} ) = \frac{( {V}_{dn} ( dn 1 + {V}_{dn} ) ) \cdot ( {a}_{n} {V}_{dd} + {b}_{n} ( dn 1 + {V}_{dd} ) )}{( {V}_{dd} ( dn 1 + {V}_{dd} ) ) \cdot ( {a}_{n} {V}_{dn} + {b}_{n} ( dn 1 + {V}_{dn} ) )}$$

The function of the normalized adjusted drain voltage for an n channel MOS transistor equation is derived from the relationship between, as an example, the total resistances of two resistors in parallel as shown in reduced form in a total resistance equation.

$$R = \frac{{R}_{a} \cdot {R}_{b}}{{R}_{a} + {R}_{b}}$$

This relationship states that the equivalent resistance of two resistors connected in parallel is equal to the sum of the inverse of the individual resistances. Of course this type of relationship is also present in determining the total capacitance of two capacitors in series, as well as any other relationship in which the total is equivalent to the ratio of the product of the individuals to the sum of the individuals. The relationship of the total resistance equation is used to formulate the normalized adjusted drain voltage for an n channel MOS transistor equation in which the normalized adjusted drain voltage for an n channel MOS transistor equation is actually the ratio of two different uses of the total resistance equation. There are several constants shown in the normalized adjusted drain voltage for an n channel MOS transistor equation including, with the units shown in parenthesis, the first drain curve parameter for the n transistor dn1 [ ], constant aₙ shown in a first drain constant voltage for an n channel MOS transistor equation in which a second drain curve parameter for the n transistor dn0 [ ] is shown, the positive supply voltage V_{dd} [mV], and constant bₙ shown in a second drain constant voltage for an n channel MOS transistor equation.

$${a}_{n} = \frac{dn 0}{100 \cdot {V}_{dd}} , {b}_{n} = \frac{1}{dn 1 + {V}_{dd}}$$

In performing the computation of the normalized adjusted drain voltage for an n channel MOS transistor equation in a step 3010, there are five total arithmetic operations of division. Two of the five divisions necessary in formulating the normalized adjusted drain voltage data 540 are not shown, as the normalized adjusted drain voltage for an n channel MOS transistor equation is the simplified form of the ratio of the two uses of the total resistance equation. A multiplication factor k is used to preserve the precision for each of the five divisions having a net effect of producing a value in block 3010 that is only a factor of k greater than the direct calculation of the normalized adjusted drain voltage for an n channel MOS transistor equation with floating point arithmetic.

In a step 3015 the normalized adjusted drain voltage data value produced in the step 3010 is stored into the dn table 540 at a position designated by the argument to the function of the normalized adjusted drain voltage for an n channel MOS transistor equation. The formulation of the dn table 540 is done so that the last element of the dn table 540 contains f_{dn}(cᵥV_{dd}), the second to last element of the dn table 540 contains f_{dn}(cᵥV_{dd}+1), and so on until the 125th element of the dn table 540 contains f_{dn}(Vₛₛ). For example, Vₛₛ is 0 mV, cᵥ is 1.0683, and V_{dd} is 1800 mV, resulting in the last element of the dn table 540 contains f_{dn}(1923), the second to last element of the dn table 540 contains f_{dn}(1922), and so on until the 125th element of the dn table 540 contains f_{dn}(0). However, in a step 3015 only one element of the dn table 540 is filled. Moving to a step 3020 the drain voltage is decremented and is compared to a stop value Vₛₛ in a step 2025. For example, Vₛₛ is 0 mV resulting in the stop value 0 mV. The decrement is preferably one millivolt, but an alternative decrement may be used. A yes from the step 3025 indicates that the drain voltage is greater than or equal to 0 mV and step 3010 is repeated. A no from the step 3025 indicates that the drain voltage is less than 0 mV and a step 3030 which formulates the remainder of the dn table 540 is performed.

In the step 3030 the first 124 elements of the dn table 540 are filled as a result of the previously filled elements 126-249 of the dn table 540. The first 124 elements are filled so that the first element of the dn table 540 is filled with the negation of the value already held in element 249 of the dn table 540, the second element of the dn table 540 is filled with the negation of the value already held in element 248 of the dn table 540, and so on until element 124 of the dn table 540 is the negation of the value already held in element 126 of the dn table 540. Once all 2048 elements of the dn table 540 are filled the process of formulating the dn table 540 ends the flow chart of FIG. 7a in the in a step 3035.

In an alternate embodiment the process of formulating the normalized adjusted drain voltage data in the dn table 540 is shown in a flow chart of FIG. 7b. The m elements of the dn table 540 are determined beginning with a step 3055 which initializes the gate voltage V_{dn} for an n channel MOS transistor to Vₛₛ. For example, Vₛₛ is 0 mV, resulting in an initial gate voltage of 0 mV. The dn table preferably includes 2048 elements, but alternatively a different number of elements may be used. This value is used in the step 3010 in which it is used as the argument to the function shown in the normalized adjusted drain voltage for an n channel MOS transistor equation for determining the normalized adjusted drain voltage data for the n transistor. In the step 3015 the normalized adjusted drain voltage data value produced in the step 3010 is stored into the dn table 540 at a position designated by the argument to the function of the normalized adjusted drain voltage for an n channel MOS transistor equation. Moving to a step 3060, the drain voltage is incremented and is compared to a stop value cᵥV_{dd} in a step 3065. For example, cᵥ is 1.0683 and V_{dd} is 1800 mV, resulting in the stop value 1923 mV. The increment is preferably one millivolt, but an alternative increment may be used. A yes from the step 3065 indicates that the gate voltage is less than or equal to 1923 mV and step 3010 is repeated. A no from the step 3065 indicates that the drain voltage is greater than 1923 mV and the step 3030 which formulates the remainder of the dn table 540 is performed. Once all 2048 elements of the dn table 540 are filled the process of formulating the dn table 540 ends the flow chart of FIG. 7b in the step 3035.

In one embodiment the process of formulating the normalized adjusted drain voltage data in the dp table 545 is shown in a flow chart of FIG. 8a. The m elements of the dp table 545 are determined beginning with a step 3505 which initializes the drain voltage V_{dp} for a p channel MOS transistor to cᵥV_{dd} where cᵥ is a power supply voltage coefficient that can be chosen according to the simulation being performed. For example, cᵥ is 1.0683 and V_{dd} is 1800 mV, resulting in an initial drain voltage of 1923 mV. The dp table preferably includes 2048 elements, but alternatively a different number of elements may be used. The drain voltage is used in a step 3510 wherein it is the argument to the function shown in a normalized adjusted drain voltage for a p channel MOS transistor equation.

$${f}_{dp} ( {V}_{dp} ) = \frac{( {V}_{dp} ( dp 1 + {V}_{dp} ) ) \cdot ( {a}_{p} {V}_{dd} + {b}_{p} ( dp 1 + {V}_{dd} ) )}{( {V}_{dd} ( dp 1 + {V}_{dd} ) ) \cdot ( {a}_{p} {V}_{dp} + {b}_{p} ( dp 1 + {V}_{dp} ) )}$$

Like the normalized adjusted drain voltage for an n channel MOS transistor equation, the function in the normalized adjusted drain voltage for a p channel MOS transistor equation is the ratio of two different uses of the total resistance equation. There are several constants shown in the normalized adjusted drain voltage for a p channel MOS transistor equation including, with the units shown in parenthesis, the first drain curve parameter for the n transistor dp1 [ ], constant aₚ shown in a first drain constant voltage for a p channel MOS transistor equation in which a second drain curve parameter for the n transistor dp0 [ ] is shown, the positive supply voltage V_{dd} [mV], and constant bₚ shown in a second drain constant voltage for a p channel MOS transistor equation.

$${a}_{p} = \frac{dp 0}{100 \cdot {V}_{dd}} , {b}_{p} = \frac{1}{dp 1 + {V}_{dd}}$$

In performing the computation of the normalized adjusted drain voltage for a p channel MOS transistor equation, in a step 3510 there are five total arithmetic operations of division. Two of the five divisions necessary in formulating the normalized adjusted drain voltage data 545 are not shown, as the normalized adjusted drain voltage for a p channel MOS transistor equation is the simplified form of the ratio of the two uses of the total resistance equation. A multiplication factor k is used to preserve the precision for each of the five divisions having a net effect of producing a value in block 3510 that is only a factor of k greater than the direct calculation of the normalized adjusted drain voltage for a p channel MOS transistor equation with floating point arithmetic.

In a step 3515 the normalized adjusted drain voltage data value produced in the step 3510 is stored into the dp table 545 at a position designated by the argument to the function of the normalized adjusted drain voltage for a p channel MOS transistor equation. The formulation of the dp table 545 is done so that the last element of the dp table 545 contains f_{dp}(cᵥV_{dd}), the second to last element of the dp table 545 contains f_{dp}(cᵥV_{dd}+1), and so on until the 125th element of the dp table 545 contains f_{dp}(Vₛₛ). Vₛₛ is 0 mV, cᵥ is 1.0683, and V_{dd} is 1800 mV, resulting in the last element of the dp table 545 contains f_{dp}(1923), the second to last element of the dp table 545 contains f_{dp}(1922), and so on until the 125th element of the dp table 545 contains f_{dp}(0). However, in a step 3515 only one element of the dp table 545 is filled. Moving to a step 3520, the drain voltage is decremented and is compared to a stop value Vₛₛ in a step 3525. For example, Vₛₛ is 0 mv, resulting in the stop value 0 mV. The decrement is preferably one millivolt, but an alternative decrement may be used. A yes from the step 3525 indicates that the drain voltage is greater than or equal to 0 mV and step 3510 is repeated. A no from the step 3525 indicates that the drain voltage is less than 0 mV and a step 3530 which formulates the remainder of the dp table 545 is performed.

In the step 3530 the first 124 elements of the dp table 545 are filled as a result of the previously filled elements 126-249 of the dp table 545. The first 124 elements are filled so that the first element of the dp table 545 is filled with the negation of the value already held in element 249 of the dp table 545, the second element of the dp table 545 is filled with the negation of the value already held in element 248 of the dp table 545, and so on until element 124 of the dp table 545 is the negation of the value already held in element 126 of the dp table 545. Once all 2048 elements of the dp table 545 are filled, the process of formulating the dp table 545 of the flow chart of FIG. 8a ends in a step 3535.

In an alternate embodiment, the process of formulating the normalized adjusted drain voltage data in the dp table 545 is shown in a flow chart of FIG. 8b. The m elements of the dp table 545 are determined beginning with a step 3555 which initializes the gate voltage V_{dn} for an n channel MOS transistor to Vₛₛ. For example, Vₛₛ is 0 mV, resulting in an initial gate voltage of 0 mV. The dn table preferably includes 2048 elements, but alternatively a different number of elements may be used. This value is used in the step 3510 in which it is used as the argument to the function shown in the normalized adjusted drain voltage for a p channel MOS transistor equation for determining the normalized adjusted drain voltage data for the n transistor. In the step 3515 the normalized adjusted drain voltage data value produced in the step 3510 is stored into the dn table 540 at a position designated by the argument to the function of the normalized adjusted drain voltage for a p channel MOS transistor equation. Moving to a step 3560, the drain voltage is incremented and is compared to a stop value cᵥV_{dd} in a step 3565. For example, cᵥ is 1.0683 and V_{dd} is 1800 mV, resulting in the stop value 1923 mV. The increment is preferably one millivolt, but an alternative increment may be used. A yes from the step 3565 indicates that the gate voltage is less than or equal to 1923 mV and step 3510 is repeated. A no from the step 3565 indicates that the drain voltage is greater than 1923 mV and the step 3530 which formulates the remainder of the dn table 540 is performed. Once all 2048 elements of the dp table 545 are filled, the process of formulating the dp table 545 of the flow chart of FIG. 8b ends in the step 3535.

In one embodiment, the process of formulating the normalized adjusted temperature data in the t3/2 table 550 is shown in a flow chart of FIG. 9a. The m elements of the t3/2 table 550 are determined beginning with a step 4005 which initializes the increment to the ambient temperature T_{inc} to Tₘₐₓ, where Tₘₐₓ is a maximum increment to the ambient temperature. For example, Tₘₐₓ is 1999K, resulting in an initial increment to the ambient temperature of 1999K. The t3/2 table preferably includes 2000 elements, but alternatively a different number of elements may be used. The increment to the ambient temperature is used in a step 4010 wherein it is used as the argument to the function shown in a normalized adjusted temperature equation for determining the normalized adjusted temperature data 550.

$${f}_{t 3 / 2} ( {T}_{inc} ) = {( \frac{{T}_{r}}{{T}_{a} + {T}_{inc}} )}^{\frac{3}{2}}$$

There are two constants shown in the normalized adjusted temperature equation with the units shown in parenthesis, the reference simulation temperature Tᵣ [K] and the ambient simulation temperature Tₐ [K]. A multiplication factor of k is applied to the numerator of the normalized adjusted temperature equation in the step 4010 to avoid a loss of precision when the integer data type is used to perform the computation of the normalized adjusted temperature equation. Additionally, due to the integer data type and the required three halves exponent in the normalized adjusted temperature equation, Newton's method is applied in which several more divisions occur. However, the net result is that the value produced when performing the computation of the normalized adjusted temperature equation is a factor of k greater than the computation of the normalized adjusted temperature equation with floating point arithmetic.

In a step 4015 the normalized adjusted temperature data value produced in the step 4010 is stored into the t3/2 table 550 at a position designated by the argument to the function of the normalized adjusted temperature equation. The formulation of the t3/2 table 550 is done so that the last element of the t3/2 table 550 contains f_{t3/2}(1999), the second to last element of the t3/2 table 550 contains f_{t3/2}(1998), and so on until the first element of the t3/2 table 550 contains f_{t3/2}(0). However, in a step 4015 only one element of the t3/2 table 550 is filled. Moving to a step 4020, the increment to the ambient temperature is decremented and is compared to a stop value Tₘᵢₙ in a step 4025. For example, Tₘᵢₙ is 0K, resulting in the stop value 0K. The decrement is preferably one Kelvin, but an alternative decrement may be used. A yes from the step 4025 indicates that the increment to the ambient temperature is greater than or equal to 0 mV and step 4010 is repeated. A no from the step 4025 indicates that the increment to the ambient temperature is less than 0K and the flow chart of FIG. 9a ends in a step 4030.

In an alternate embodiment, the process of formulating the normalized adjusted temperature data in the t3/2 table 550 is shown in a flow chart of FIG. 9b. The m elements of the t3/2 table 550 are determined beginning with a step 4555 which initializes the increment to the ambient temperature T_{inc} to Tₘᵢₙ where Tₘᵢₙ is the minimum increment to the ambient temperature. For example, Tₘᵢₙ is 0K, resulting in an initial increment to the ambient temperature of 0K. The t3/2 table preferably includes 2000 elements, but alternatively a different number of elements may be used. The increment to the ambient temperature is used in the step 4010 in which it is used as the argument to the function shown in the normalized adjusted temperature equation for determining the normalized adjusted temperature data. In the step 4015, the normalized adjusted temperature data value produced in the step 4010 is stored into the t3/2 table 550 at a position designated by the argument to the function of the normalized adjusted temperature equation. Moving to a step 4560, the increment to the ambient temperature is incremented and is compared to a stop value Tₘₐₓ in a step 4065. For example, Tₘₐₓ is 1999K, resulting in the stop value 1999K. The increment is preferably one Kelvin, but an alternative increment may be used. A yes from the step 4565 indicates that the increment to the ambient temperature is less than or equal to 1999K and step 4010 is repeated. A no from the step 4565 indicates that the increment to the ambient temperature is greater than 1999K and the flow chart of FIG. 9b ends in the step 4030.

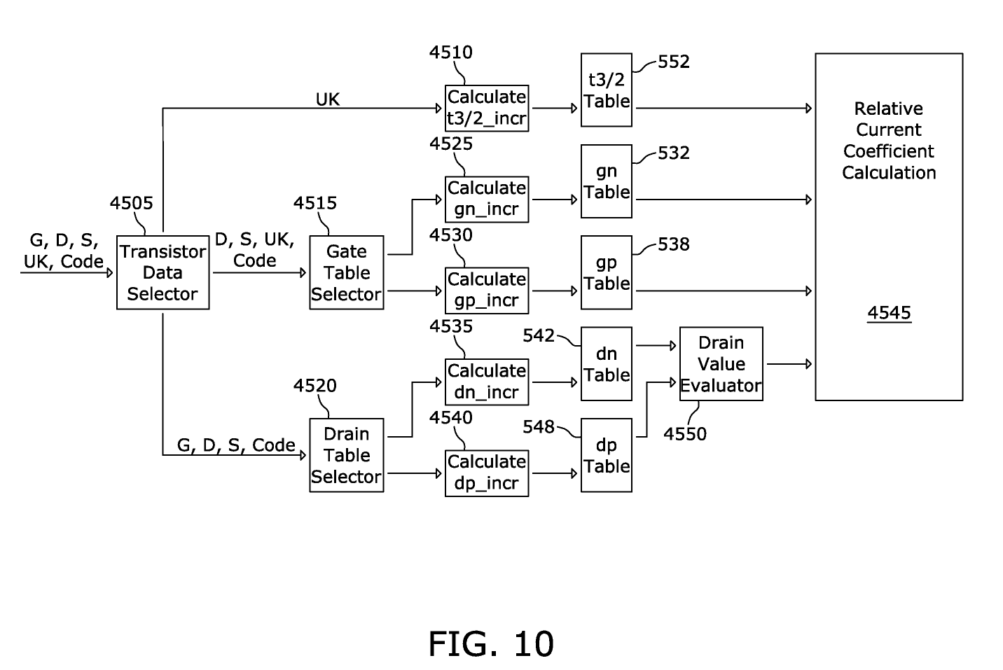

FIG. 10 shows a block diagram for the process of determining the relative current coefficient C from the transistor current equation used to determine the current through a transistor during simulation. In a transistor data selector 4505, the numerical values for the transistor type also referred to as CODE, the temperature of the transistor also referred to as UK, the coordinates of the transistor's gate also referred to as G, the coordinates of the transistor's drain also referred to as D, and the coordinates of the transistor's source also referred to as S, are fetched from the transistor table 555 for the specific transistor in which the relative current coefficient is calculated. The transistor data selector 4505 will pass the UK value to an increment 4510 into the t3/2 table. The increment 4510 is determined from a t3/2 increment equation defined as the sum of the UK value and the base address temp of the t3/2 table 550.

t3/2_{incr}(UK)=UK+temp

The transistor data selector 4505 also passes the D, S, and CODE values to a gate table selector 4515, and the G, D, S, and CODE values to a drain table selector 4520. The gate table selector 4515 uses the CODE value to select the path to either an increment calculation 4525 into the gn table 530 or an increment calculation 4530 into the gp table 535.

The increment calculation 4525 is dependent on whether the CODE of the transistor represents an (n-) transistor type or an (n pass) transistor type. For an (n-) transistor type the increment calculation 4525 is determined from a gn increment equation for an (n-) transistor type defined as the sum of two values in which the first value is simply the base address gn of the gn table 530. The second value in the sum is the maximum of zero and the sum of the G value and the product of the UK value with the millivolts per Kelvin constant C_{mv/k}.

gn_{inc, n-}(G, UK)=max(0, G+UK·C_{mv/k})+gn

For an (n pass) transistor type the increment calculation 4525 is determined from a gn increment equation for an (n pass) transistor type defined as the sum of two values in which the first is the base address gn of the gn table 530. The second is the maximum of two values, zero or the difference between the value G and the minimum of D or S added to the product of UK and the millivolts per Kelvin constant C_{mv/k}.

gn_{incr,n pass}(G, D, S UK)=max(0, G−min(D, S)+UK·C_{mv/k})+gn

The increment calculation 4530 is dependent on whether the CODE of the transistor represents a (p-) transistor type or a (p pass) transistor type. For a (p-) transistor type the increment calculation 4530 is determined from a gp increment equation for a (p-) transistor type defined as the sum of two values in which the first value is simply the base address gp of the gp table 535. The second value in the sum is the maximum of zero and the sum of the G value and the product of the UK value with the millivolts per Kelvin constant C_{mv/k}.

gp_{incr, p-}(G, UK)=max(0, (V_{dd}−G)+UK·C_{mv/k})+gp

For a (p pass) transistor type, the increment calculation 4530 is determined from a gp increment equation for a (p pass) transistor type defined as the sum of two values in which the first is the base address gp of the gp table 535. The second is the maximum of two values, zero or the difference between the value G and the minimum of D or S added to the product of UK and the millivolts per Kelvin constant C_{mv/k}. The second value in the sum is the maximum of zero or the difference between the positive supply voltage V_{dd} and the minimum of the positive supply voltage V_{dd} and the value D or the difference between the value D and S with the value G subtracted and the product of the value UK with the millivolts per Kelvin constant C_{mv/k}.

gp_{incr, p pass}(G, D, S, UK)=max(0, V_{dd}−min(V_{dd}−D, D−S)−G+UK·C_{mv/k})+gp

Similarly, the drain table selector 4520 uses the CODE value to select the path to either an increment calculation 4535 into the dn table 540 or an increment calculation 4540 into the dp table 545.

The increment calculation 4535 is dependent on whether the CODE of the transistor represents an (n-) transistor type or an (n pass) transistor type. For an (n-) transistor type the increment calculation 4535 is determined from a dn increment equation for an (n-) transistor type defined as the sum of two values in which the first value is simply the base address dn of the dn table 540 and the second is the D value.

dn_{incr, n-}(D)=D+dn

For an (n pass) transistor type the increment calculation 4535 is actually two calculations as two values are selected from the dn table 540. The first increment calculation 4535 is the same as the one presented for an (n-) transistor shown in the dn increment equation for an (n-) transistor type. The second increment calculation 4535 is determined from a dn increment equation for an (n pass) transistor type defined as the sum of two values in which the first value is simply the base address dn of the dn table 540 and the second is the S value.

dn_{incr, n pass}(S)=S+dn

The increment calculation 4540 is dependent on whether the CODE of the transistor represents a (p-) transistor type or a (p pass) transistor type. For a (p-) transistor type the increment calculation 4540 is determined from a dp increment equation for a (p-) transistor type defined as the sum of two values in which the first is the base address dp of the dp table and the second is the difference between the positive supply voltage V_{dd} and the D value.

dp_{incr, p-}(D)=(V_{dd}−D)+dp

For a (p pass) transistor type the increment calculation 4540 is actually two calculations as two values are selected from the dn table 540. The first increment calculation 4540 is the same as the one presented for a (p-) transistor shown in the dp increment equation for a (p-) transistor type. The second increment calculation 4540 is determined from a dp increment equation for a (p pass) transistor type defined as the sum of two values in which the first value is simply the base address dp of the dp table 545 and the second is the difference between the positive supply voltage V_{dd} and the S value.

dp_{incr, p pass}(S)=(V_{dd}−S)+dp

Referring back to the increment calculation 4510 and the t3/2 table 550, a single increment into the t3/2 table is calculated in the increment calculation 4510 and that increment is used to select and pass a single value from the t3/2 table to a relative current coefficient calculation 4545. Referring back to the increment calculation 4525 and the gn table 530 along with the increment calculation 4530 and the gp table 535, the gate table selector 4515 specifies which increment calculation and thus the appropriate increment into the corresponding table from which to select a single value that is passed to the relative current coefficient calculation 4545.

Referring back to the increment calculation 4535 and the dn table 540 along with the increment calculation 4540 and the dp table 545, the drain table selector 4515 specifies which increment calculation(s) and thus the appropriate increment(s) into the corresponding table from which to select value(s) that are evaluated in a drain table calculation 4550. Recall that for an (n-) transistor only one increment calculation 4535 is performed and only one value is selected from the dn table 540 which is then passed to the drain table value calculation 4550 in which the value is simply passed to the relative current coefficient calculation 4545. For an (n pass) transistor two increments into the dn table 540 are needed from the increment calculation 4535 and therefore two values from the dn table 540 are selected and then passed onto the drain table value calculation 4550. The drain table value calculation 4550 will for the (n pass) transistor subtract the value fetched from the dn table 540 specified in the dn increment equation for an (n pass) transistor type from the value fetched from the dn table 540 specified in the dn increment equation for an (n-) transistor type and then pass this result onto the relative current coefficient calculation 4545.

Recall that for a (p-) transistor only one increment calculation 4540 is performed and only one value is selected from the dp table 545 which is then passed to the drain table value calculation 4550 in which the value is simply passed to the relative current coefficient calculation 4545. For a (p pass) transistor two increments into the dp table 545 are needed from the increment calculation 4540 and therefore two values from the dp table 545 are selected and then passed onto the drain table value calculation 4550. The drain table value calculation 4550 will for the (p pass) transistor subtract the value fetched from the dp table 545 specified in the dp increment equation for a (p pass) transistor type from the value fetched from the dp table 545 specified in the dp increment equation for a (p-) transistor type and then pass this result onto the relative current coefficient calculation 4545.

The relative current coefficient calculation 4545 will use three input values for each transistor to produce the relative current coefficient C used in the transistor current equation for determining the current I through the transistor. For an (n-) transistor type the relative current coefficient Cₙ₋ calculated in the relative current coefficient calculation 4545 is determined from a relative current coefficient for an (n-) transistor type equation defined as the product of the three values fetched from the location specified by the increment into the gn table 530 in the gn increment equation for an (n-) transistor type, increment into the dn table 540 in the dn increment equation for an (n-) transistor type, and the increment into the t3/2 table 550 in the t3/2 increment equation.

Cₙ₋=gn(G, UK)·dn(D)·t3/2(UK)

For an (n pass) transistor type the relative current coefficient C_{n pass} is calculated in the relative current coefficient calculation 4545 and is determined from a relative current coefficient for an (n pass) transistor type equation defined as the product of the three values fetched from the location specified by the increment into the gn table 530 in the gn increment equation for an (n pass) transistor type, increments into the dn table 540 in the dn increment equation for an (n-) transistor type and the dn increment equation for an (n pass), and the increment into the t3/2 table 550 in the t3/2 increment equation.

C_{n pass}=gn(G, D, S UK)·[dn(D)−dn(S)]·t3/2(UK)

For a (p-) transistor type the relative current coefficient Cₚ₋ calculated in the relative current coefficient calculation 4545 is determined from a relative current coefficient for a (p-) transistor type equation defined as the product of the three values fetched from the location specified by the increment into the gp table 535 in the gp increment equation for a (p-) transistor type, increment into the dp table 545 in the dp increment equation for a (p-) transistor type, and the increment into the t3/2 table 550 in the t3/2 increment equation.

Cₚ₋=gp(G, UK)·dp(D)·t3/2(UK)

For a (p pass) transistor type the relative current coefficient C_{p pass} is calculated in the relative current coefficient calculation 4545 and is determined from a relative current coefficient for a (p pass) transistor type equation defined as the product of the three values fetched from the location specified by the increment into the gp table 535 in the gp increment equation for a (p pass) transistor type, increments into the dp table 545 in the dp increment equation for a (p-) transistor type and the dp increment equation for a (p pass) transistor type, and the increment into the t3/2 table 550 in the t3/2 increment equation.

C_{p pass}=gp(G, D, S UK)·[dp(D)−dp(S)]·t3/2(UK)

Numerous modifications, variations and adaptations may be made to the particular embodiments described above without departing from the scope patent disclosure, which is defined in the claims.

What is claimed is:

1. A method for integrated circuit simulation comprising the steps of:
a) providing a voltage lookup table having predetermined drain voltage data for a given transistor type;
b) providing a voltage lookup table having predetermined gate voltage data for a given transistor type;
c) providing a temperature lookup table having predetermined temperature data;
d) providing a transistor lookup table having predetermined current and temperature data;
e) simulating operation of an integrated circuit by, for each transistor in the integrated circuit, determining a current value through the transistor in dependence upon one of the predetermined voltage data values and one of the predetermined temperature data values; and
f) comparing the current value calculated in step e to the current value obtained from step d;
g) updating non quiescent current transistor table detecting a change in the current value in step f,
h) incrementing a simulation time step and repeating steps (e-g) for all transistors;
i) simulating operation of an integrated circuit by, for each transistor in the integrated circuit, determining a transistor temperature value for all transistor apart of the non quiescent current transistor table from step f;
j) discarding the transistor names from the non quiescent current transistor table;

2. The method for integrated circuit simulation of claim 1 wherein:
the given transistor type is selected from an n-transistor used to form an inverter, a p-transistor used to form an inverter, an n-transistor used to form a pass gate and a p-transistor used to form a pass gate;

3. The method for integrated circuit simulation of claim 2 wherein:
the voltage lookup table has addresses corresponding to one of gate voltage and drain voltage in dependence upon transistor type;

4. The method for integrated circuit simulation of claim 3 wherein:
an incremental change in voltage causes a corresponding incremental change in voltage lookup table address;

5. The method for integrated circuit simulation of claim 2 wherein:
each transistor type has a corresponding lookup table;

6. The method for integrated circuit simulation of claim 1 wherein:
the temperature lookup table has addresses corresponding to the temperature of the transistor;

7. The method for integrated circuit simulation of claim 3 wherein:
an incremental change in temperature causes a corresponding incremental change in temperature lookup table address;

8. The method for integrated circuit simulation of claim 1 wherein:
the step of determining a current value through a transistor uses a transistor current equation;

9. The method for integrated circuit simulation of claim 8 wherein:
the constant C is dependent upon transistor type;

10. The method for integrated circuit simulation of claim 8 wherein:
the constant C is determined using a relative current coefficient for an (n-) transistor type equation, a relative current coefficient for an (n pass) transistor type equation, a relative current coefficient for a (p-) transistor type equation, or a relative current coefficient for an (n pass) transistor type equation in dependence upon transistor type;

11. An integrated circuit simulator comprising:
a) providing a voltage lookup table having predetermined drain voltage data for a given transistor type;
b) providing a voltage lookup table having predetermined gate voltage data for a given transistor type;
c) a temperature lookup table having predetermined temperature data;
d) a transistor lookup table having predetermined current and temperature data;
e) a simulation engine for each transistor in the integrated circuit, determining a current value through the transistor in dependence upon one of the predetermined voltage data values and one of the predetermined temperature data values;
f) a non quiescent current transistor table to store the transistor name;
g) a simulation engine for each transistor in the integrated circuit, determining a transistor temperature value for transistors in the non quiescent current transistor table; and
h) a clock for incrementing a simulation time step and repeating steps (e-f) for those transistors for which an incremental change has occurred in one of temperature, voltage and power;

12. The integrated circuit simulator of claim 11 wherein:
the given transistor type is selected from an n-transistor used to form an inverter, a p-transistor used to form an inverter, an n-transistor used to form a pass gate and a p-transistor used to form a pass gate;

13. The integrated circuit simulator of claim 12 wherein:
the voltage lookup table has addresses corresponding to one of gate voltage and drain voltage in dependence upon transistor type;

14. The integrated circuit simulator of claim 13 wherein:
an incremental change in voltage causes a corresponding incremental change in voltage lookup table address;

15. The integrated circuit simulator of claim 12 wherein:
each transistor type has a corresponding lookup table;

16. The integrated circuit simulator of claim 11 wherein:
the temperature lookup table has addresses corresponding to the temperature of the transistor;

17. The integrated circuit simulator of claim 13 wherein:
an incremental change in temperature causes a corresponding incremental change in temperature lookup table address;

18. The integrated circuit simulator of claim 11 wherein:
determining a current value through a transistor uses the transistor current equation;

19. The integrated circuit simulator of claim 18 wherein:
the constant C is dependent upon transistor type;

20. The integrated circuit simulator of claim 18 wherein:
the constant C is determined using a relative current coefficient for an (n-) transistor type equation, a relative current coefficient for an (n pass) transistor type equation, a relative current coefficient for a (p-) transistor type equation or a relative current coefficient for an (n pass) transistor type equation in dependence upon transistor type;

21. A method for integrated circuit simulation comprising the steps of:
a) providing a voltage lookup table having predetermined drain voltage data for a given transistor type;
b) providing a voltage lookup table having predetermined gate voltage data for a given transistor type;
c) providing a temperature lookup table having predetermined temperature data;
d) providing a transistor lookup table having predetermined current and temperature data;
e) simulating operation of an integrated circuit by, for each transistor in the integrated circuit, determining a current value through the transistor in dependence upon one of the predetermined voltage data values and one of the predetermined temperature data values; and
f) comparing the current value calculated in step e to the current value obtained from step d;
g) updating non quiescent current transistor table on detecting a change in the current value in step f, and on detecting the transistor's presence in a non quiescent temperature list;
h) incrementing a simulation time step and repeating steps (e-g) for all transistors;
i) simulating operation of an integrated circuit by, for each transistor in the integrated circuit, determining a transistor temperature value for all transistor in the non quiescent current transistor table from step f and additionally including a transistor in the non quiescent temperature list if the transistor temperature value is different from the prior value by a predetermined temperature increment; and
j) discarding the transistor from the non quiescent current transistor table and discarding the transistor from the non quiescent temperature list.
